(19) United States
(12) Patent Application Publication
(10) Pub. No.: US 2019/0359488 A1
(43) Pub. Date: Nov. 28, 2019

(54) APPARATUS AND METHODS OF FORMING SOLID CARBON

(71) Applicant: Seerstone LLC, Provo, UT (US)

(72) Inventors: Randall Smith, Sandy, UT (US); Dallas B. Noyes, Provo, UT (US)

(21) Appl. No.: 16/476,859

(22) PCT Filed: Jan. 9, 2018
(86) PCT No.: PCT/US2018/012944

§ 371 Date: Jul. 9, 2019

Related U.S. Application Data
(60) Provisional application No. 62/444,587, filed on Jan. 10, 2017.

(51) Int. Cl. C01B 32/162; B01J 31/04; B05B 5/03; B05B 5/053; B01J 19/18

(52) U.S. Cl. CPC C01B 32/162; B01J 31/04; B01J 2231/70; B05B 5/0533; B01J 19/1812; B05B 5/032

(57) ABSTRACT

A method of reducing a carbon oxide to a lower oxidation state by providing a solution of a metal acetate in a solvent in a reaction vessel, evaporating the solvent to leave a film of the metal acetate on an interior surface of the reaction vessel, and reacting a carbon oxide with a gaseous reducing agent in the reaction vessel to produce a solid carbon product on the metal acetate is disclosed. Another method includes dispersing particles in a gas. The particles include a solution of a metal acetate in a solvent. The solvent is evaporated to form particles including the metal acetate. An apparatus includes a capillary tube configured to receive and emit a solution, an electrode, and a voltage source connected to the capillary tube, the voltage source having a higher potential than the electrode.

### CROSS-REFERENCE TO RELATED APPLICATIONS

This application is a national phase entry under 35 U.S.C. § 371 of International Patent Application PCT/US2018/012944, filed Jan. 9, 2018, designating the United States of America and published in English as International Patent Publication WO 2018/132373 A2 on Jul. 19, 2018, which claims the benefit under 35 U.S.C. § 119(e) and Article 8 of the Patent Cooperation Treaty to U.S. Provisional Patent Application Ser. No. 62/444,587, filed Jan. 10, 2017, for “Iron Acetate Catalyst for Carbon Reactions,” the contents of each of which are incorporated herein in their entirety by this reference.

### TECHNICAL FIELD

Embodiments of the disclosure relate to the catalytic conversion of a carbon-containing feedstock into solid carbon, and, more specifically, to methods of converting mixtures of carbon monoxide, carbon dioxide, or any combination thereof to create carbon nanotubes, carbon nanofibers, nanodiamond, etc.

### BACKGROUND

Solid carbon has numerous commercial applications. For example, carbon black and carbon fibers may be used as a filler material in tires, inks, etc., and graphite may be used in heat shields. Innovative and emerging applications for buckminsterfullerenes, carbon nanotubes, and carbon nanofibers are being developed.

As used herein, the term “carbon nanotube” or “CNT” means and includes a hollow cylindrical carbon molecule, defining a void therein, which may be empty or filled with another material. CNTs may be closed at one or both ends. CNTs may be conceptualized as rolled graphene sheets, having a hexagonal lattice of carbon molecules.

As used herein, the term “carbon nanofiber” or CNF means and includes a carbon-containing material comprising a solid cylindrical shape substantially free of voids (e.g., without a hollow central portion). A carbon nanofiber may be similar to a CNT, but may include a solid core rather than a hollow central portion. CNFs may be conceptualized as stacked discs of graphene. As used herein, the terms “fibrous nanoparticles” and “carbon nanoparticles” each include nanofibers, nanotubes, and combinations thereof.

CNFs and CNTs have been found to have numerous valuable uses. The cross-sectional diameter of the tube or fiber affects the properties of the tube or fiber. Typically, a smaller diameter CNT such as a single-wall CNT is more electrically conductive, whereas larger (typically multi-wall) CNTs are less conductive but provide better strengthening in fillers and other industrial uses.

CNFs, CNTs, and other nano-sized carbon morphologies are typically formed using catalyst particles, such as iron. The size of the catalyst particle affects the size of the resulting nanoparticles. For example, a smaller catalyst particle typically produce a carbon fiber or CNT having a smaller cross-section or diameter. Conventionally, catalyst particle size is typically controlled by chemical vapor deposition, which can be relatively expensive and is often not conducive to continuous CNT and CNF production methods.

Conventional methods for the manufacture of various forms of solid carbon typically involve the pyrolysis of hydrocarbons in the presence of a suitable catalyst. Hydrocarbons are typically used as the carbon source. Carbon oxides have also been explored as a source of solid carbon, as described in U.S. Pat. No. 8,679,444, “Method for Producing Solid Carbon by Reducing Carbon Oxides,” issued Mar. 25, 2014, the entire disclosure of which is incorporated herein by reference. Carbon oxides, particularly carbon dioxide, are abundant gases that may be extracted from point-source emissions such as well gases, exhaust gases of hydrocarbon combustion, or from some process off-gases.

There is a spectrum of reactions involving carbon, oxygen, and hydrogen wherein various equilibria have been identified. Hydrocarbon pyrolysis involves equilibria between hydrogen and carbon that favors solid carbon production, typically with little or no oxygen present. The Boudouard reaction, also called the “carbon monoxide disproportionation reaction,” is the range of equilibria between carbon and oxygen that favors solid carbon production, typically with little or no hydrogen present. The Bosch reaction occurs within a region of equilibria where carbon, oxygen, and hydrogen are each present under reaction conditions that also favor solid carbon production.

The relationship between the hydrocarbon pyrolysis, Boudouard, and Bosch reactions may be understood in terms of a C—H—O equilibrium diagram, as shown in FIG. 1. The C—H—O equilibrium diagram of FIG. 1 shows various known routes to solid carbon, including CNTs. The hydrocarbon pyrolysis reactions occur on the equilibrium line that connects H and C and in the region near the left edge of the triangle to the upper left of the dashed lines. Two dashed lines are shown because the transition between the pyrolysis zone and the Bosch reaction zone may change with reactor temperature. The Boudouard, or carbon monoxide disproportionation reactions, occur near the equilibrium line that connects O and C (i.e., the right edge of the triangle). The equilibrium lines for various temperatures that traverse the diagram show the approximate regions in which solid carbon will form. For each temperature, solid carbon may form in the regions above the associated equilibrium line, but will not generally form in the regions below the equilibrium line. The Boudouard reaction zone appears at the right side of the triangle. In this zone, the Boudouard reaction is thermodynamically preferred over the Bosch reaction. In the region between the pyrolysis zone and the Boudouard reaction zone and above a particular reaction temperature curve, the Bosch reaction is thermodynamically preferred over the Boudouard reaction.

### BRIEF SUMMARY

A method of reducing a carbon oxide to a lower oxidation state includes providing a solution of a metal acetate in a solvent in a reaction vessel, evaporating the solvent to leave a film of the metal acetate on an interior surface of the reaction vessel, and reacting a carbon oxide with a gaseous reducing agent in the reaction vessel to produce a solid carbon product on the metal acetate.

Another method of reducing a carbon oxide to a lower oxidation state includes dispersing particles in a gas. The particles include a solution of a metal acetate in a solvent. The solvent is evaporated to form particles including the metal acetate. A carbon oxide reacts with a gaseous reducing agent in the presence of the particles to produce a solid carbon product thereon.

An apparatus for forming solid carbon includes a capillary tube configured to receive a solution and emit the solution generally along a line perpendicular to an opening of the capillary tube, an electrode surrounding the line without intersecting the line, and a voltage source connected to the capillary tube, the voltage source having a higher potential than the electrode.

### BRIEF DESCRIPTION OF THE DRAWINGS

FIG. 1 depicts a C—H—O equilibrium diagram.

FIG. 2 is a simplified drawing illustrating a vessel that may be used to form nanostructured carbon.

FIG. 3 is a simplified drawing illustrating a process and system of using the vessel shown in FIG. 2.

FIG. 4 illustrates a continuous flow reactor in which a carbon oxide may be reduced to form solid carbon.

FIG. 5 illustrates another continuous flow reactor in which a carbon oxide may be reduced to form solid carbon.

FIG. 6 illustrates a capillary tube, such as used in the continuous flow reactor illustrated in FIG. 5.

FIG. 7 illustrates another continuous flow reactor in which a carbon oxide may be reduced to form solid carbon.

FIG. 8 shows images of material formed in the reactor illustrated in FIG. 7.

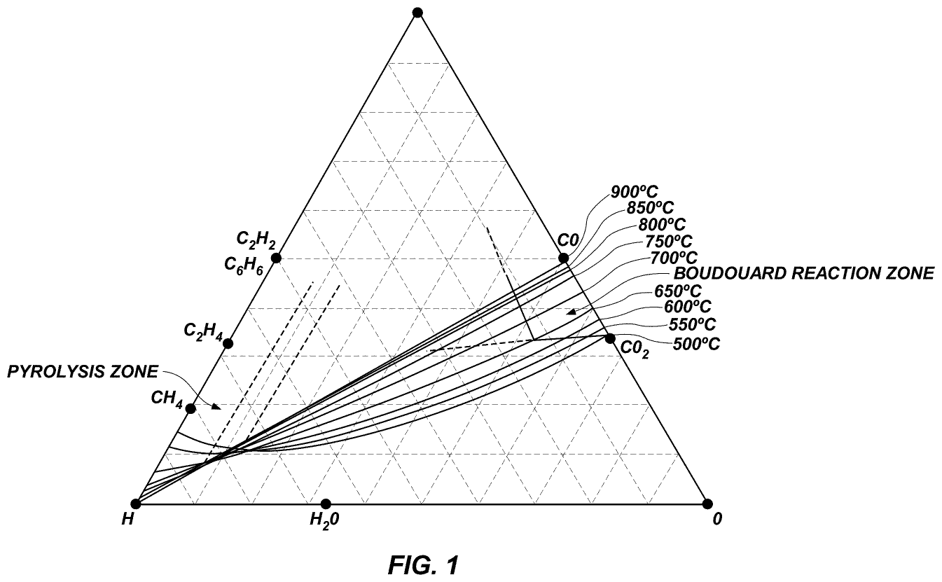

### DETAILED DESCRIPTION

The following description provides specific details, such as catalyst types, gas compositions, and processing conditions (e.g., temperatures, pressures, flow rates, reaction gas mixtures, etc.) to provide a description of embodiments of the disclosure. However, a person of ordinary skill in the art will understand that the embodiments of the disclosure may be practiced without employing these specific details. Indeed, the embodiments hereof may be practiced in conjunction with conventional systems and methods employed in the industry. In addition, only those process components and acts necessary to understand the embodiments of the disclosure are described in detail below. A person of ordinary skill in the art will understand that some process components (e.g., pipelines, line filters, valves, temperature detectors, flow detectors, pressure detectors, and the like) are inherently disclosed herein as being in common practice in the chemical processing industry and that adding various conventional process components and acts would be in accord with the disclosure. The drawings accompanying the disclosure are for illustrative purposes only, and are not meant to be actual views of any particular material, reactor, or system. Additionally, elements common between figures may retain the same numerical designation.

As used herein, the term “configured” refers to a shape, material composition, and/or arrangement of a structure or an apparatus facilitating operation the structure or the apparatus in a pre-determined or intended way. As used herein, the term “substantially,” in reference to a given parameter, property, or condition, means to a degree that one of ordinary skill in the art would understand that the given parameter, property, or condition is met with a small degree of variance, such as within 95%, within 98%, within 99%, or within 99.9%. As used herein, the singular forms “a,” “an,” and “the” are intended to include the plural forms as well, unless the context indicates otherwise.

Nanotubes and nanofibers generally grow from a nanocatalyst nucleating site on the surface of a bulk catalyst material, or from particles in an aerosol (see e.g., the incorporated U.S. Pat. No. 8,679,444). During the growth of the nanofibers, nanocatalyst particles from the surface of the bulk catalyst material may be raised from the surface of the bulk catalyst and become at least part of the growth tip of the carbon nanoparticles. The nanocatalyst particles become embedded in, attached to, or mounted on the growth tips of the carbon nanoparticles, and are supported by the resulting carbon nanoparticles. The mounted nanocatalyst particles that catalyze the formation of carbon nanoparticles are typically catalyst particles for catalyzing another reaction and may be suitable for many industrial reactions. By way of non-limiting example, during the reduction of carbon oxides to form carbon nanotubes, each nanotube formed may raise at least a particle of catalyst material from a surface of bulk catalyst material. Thus, a carbon nanotube formed from an iron catalyst may contain an iron particle on the tip of the carbon nanotube. Similarly, a carbon nanotube formed from nickel, chromium, ruthenium, rhodium, platinum, palladium, associated alloys thereof, or other catalyst material may have such metals embedded at the tips of the nanotubes.

Without being bound by any particular theory, it appears that the catalyst surface is slowly consumed by the formation of fibrous carbon nanoparticles due to embedding a particle of the catalyst material into growth tips of the fibrous carbon nanoparticles. Because of this consumption, the material on which a fibrous carbon nanoparticle grows may not be considered a catalyst in the classical sense, but is nonetheless referred to herein and in the art as a “catalyst,” because the carbon is not believed to react with the material. Furthermore, fibrous carbon nanoparticles may not form at all absent the catalyst.

As an alternative theory, the reactions forming solid carbon may occur because of the presence of carbon in the catalyst material. Without being bound by any particular theory, carbon may act as a nucleating site for the reactions to proceed. Thus, the carbon in the catalyst material may promote reactions to reduce carbon oxides to solid carbon. As layers of solid carbon are formed, the newly formed carbon material may operate as nucleating sites for subsequent layers of solid carbon.

Carbon nanoparticles may be formed from a variety of catalyst materials. For example, carbon nanoparticles may be formed from elements of Groups 1-15 of the periodic table (e.g., Groups 2-11), lanthanides, actinides, oxides of such elements, alloys of such elements, and combinations thereof. Non-limiting examples of suitable catalyst materials for the formation of carbon nanoparticles include vanadium, niobium, tantalum, chromium, molybdenum, tungsten, manganese, rhenium, iron, ruthenium, osmium, cobalt, rhodium, iridium, nickel, palladium, platinum, oxides thereof, and alloys thereof.

In one embodiment, carbon nanoparticles are formed by reacting a carbon-containing gas (CO, CO₂, etc.) with a reducing agent (H₂, CH₄, etc.) in a reaction zone including a catalytic metal such as iron, nickel, chromium, platinum, palladium, ruthenium, etc., at a temperature between about 500° C. and 800° C. In one embodiment, carbon dioxide is reacted with a reducing agent to form carbon nanoparticles. In one embodiment, the reducing agent is H₂. In another embodiment, the reducing agent is a hydrocarbon (e.g., CH₄, C₂H₅, etc.) or an alcohol (e.g., methanol, etc.). In some embodiments, the reducing agent includes a mixture of one or more of these materials.

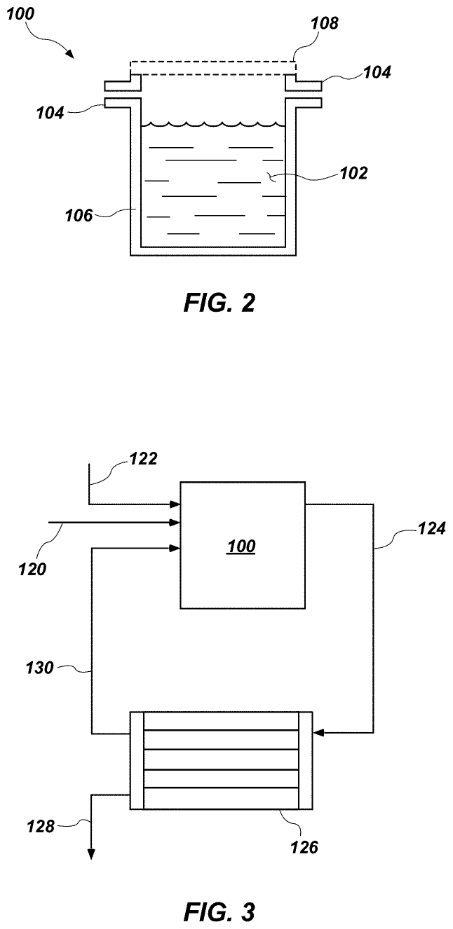

FIGS. 2 and 3 are simplified drawings illustrating systems and methods of reducing a carbon oxide to a lower oxidation state. In FIG. 2, a reaction vessel 100 is at least partially filled with a solution 102. For example, the solution 102 may be provided to the vessel 100 via a port 104 in a wall 106 of the vessel 100. For the purposes of FIG. 2, the wall 106 includes not only the lateral wall of the vessel 100, but also the floor of the vessel 100. However, the vessel 100 need not have a distinct lateral wall and floor—these parts may be a single integral outer wall. The solution 102 contains a metal acetate in a solvent. The metal acetate may be at least partially dissolved in the solvent. The metal acetate may include, for example, a transition metal, such as iron, cobalt, nickel, copper, silver, platinum, etc. In some embodiments, the metal acetate may be iron (III) acetate, [Fe₃O(OAc)₆(H₂O)₃]OAc, iron (II) acetate, Fe₃(OAc)₂, nickel acetate, Ni(OAc)₂.2H₂O or Ni(OAc)₂.4H₂O, or cobalt acetate, Co(OAc)₂.2H₂O, where OAc⁻ is CH₃CO₂⁻. The concentration of the metal acetate in the solution 102 may be between about 0.025% and about 2% by weight.

The solvent may include a material that is liquid at room temperature, such as water, an alkane, a cycloalkane, an alcohol, an acid, an aromatic compound, a ketone, etc. In some embodiments, the solvent may be methanol, ethanol, isopropanol, specially denatured alcohol (SDA) (e.g., a mixture of ethanol with tert-butyl alcohol and denatonium benzoate) or a combination or mixture containing one or more of these solvents. Water may react with some metal acetates, and therefore the solvent may be selected to be substantially free of water anhydrous (e.g., 200 proof (100%) ethanol) or may be mixed with the metal acetate shortly before use to limit the exposure time of the metal acetate to water.

The vessel 100 may be enclosed or open. For example, in some embodiments, a cover 108 may be secured to the vessel 100. In certain embodiments, the cover 108 may be integral with the wall 106. In other embodiments, the cover 108 may be omitted entirely, and the interior of the vessel 100 may be open to the atmosphere. The vessel 100 may be heated to evaporate the solvent from the solution 102, leaving the metal acetate on an interior surface of the wall 106 of the vessel 100. In some embodiments, the pressure within the vessel 100 may be reduced to flash the solvent from a liquid form to a gaseous form. For example, if the vessel 100 is closed, a vacuum pump may be connected to a port 104. The evaporation rate of the solvent may affect the properties of the metal acetate remaining on the wall 106, such as crystalline structure, density, particle size, agglomeration, etc.

In some embodiments, at least a portion of the metal acetate may be “aged” or oxidized by the solvent or another oxidizer (e.g., dissolved oxygen, oxygen in air, water, etc.) before, during, or after the solvent evaporates. A portion of the metal acetate may be decomposed to form elemental metal on the wall of the vessel 100. The metal acetate and/or elemental metal may serve as a catalyst on which further reactions occur. The amount of the metal acetate deposited on the wall of the vessel 100 may be determined by the amount of the solution 102 originally placed in the vessel 100 and on the composition of the solution 102. For example, doubling the concentration of the metal acetate in the solution 102 may double the amount of metal acetate deposited on the wall 106, all other factors being equal.

In some embodiments, the vessel 100 may be rotated, shaken, or otherwise moved while the solvent is evaporated to deposit the metal acetate more evenly over the wall 106 of the vessel 100. In other embodiments, the vessel 100 may remain stationary while the solvent is evaporated.

Once the solvent is evaporated, and as depicted in FIG. 3, a carbon oxide 120 and a gaseous reducing agent 122 may be provided to the vessel 100. The vessel 100 may be heated to or maintained at a temperature at which solid carbon forms by a reaction between the carbon oxide 120 and the gaseous reducing agent 122. For example, the carbon oxide 120 may react with the reducing agent 122 to form CNTs by the Bosch reaction, as described in U.S. Pat. No. 8,679,444. In some embodiments, the carbon oxide 120 may form CNFs, buckminsterfullerenes, nanodiamond, or another morphology of solid carbon. The metal acetate may serve as a catalyst on which the solid carbon is formed. Thus, dispersion of the metal acetate over the surface of the vessel 100 may promote uniform formation of the solid carbon over the wall 106 of the vessel 100. In some embodiments, the metal acetate may itself participate in a chemical reaction, such as by decomposing to form an elemental metal and a gas. The gas produced may react as part of the reaction gases in the vessel 100.

As discussed above, the concentration of the metal acetate in the solution 102 may affect the amount of the metal acetate remaining after the solvent evaporates. This may, in turn, affect the morphology, deposition rate, etc., of the solid carbon formed by reaction of the carbon oxide with the reducing agent.

Reaction of the carbon oxide 120 with the reducing agent 122 may form not only solid carbon, but also water. The water may be removed from the vessel 100 during the reaction. Removal of the water during the reaction may limit or prevent corrosion of the vessel 100 or the metal acetate, and may shift the reaction equilibrium. In some embodiments, and as depicted in FIG. 3, a tail gas 124 may be drawn from the vessel 100 and passed through a condenser 126 to remove water 128 as a liquid. A dried recycle gas 130 may be returned to the vessel 100. Thus, the concentration of water in the vessel 100 during the reaction may be controlled within selected parameters. For example, the concentration of water in the gases within the vessel 100 may be maintained at less than 5 mol %, less than 1 mol %, less than 0.2 mol %, or even less than 0.1 mol %.

During or after the reaction, solid carbon may be removed from the vessel 100. As a non-limiting example, the solid carbon may be removed using a lock hopper system or other means described in U.S. Patent Publication 2017/0174517, “Systems for Producing Solid Carbon by Reducing Carbon Oxides,” published Jun. 22, 2017, the entire disclosure of which is incorporated herein by this reference.

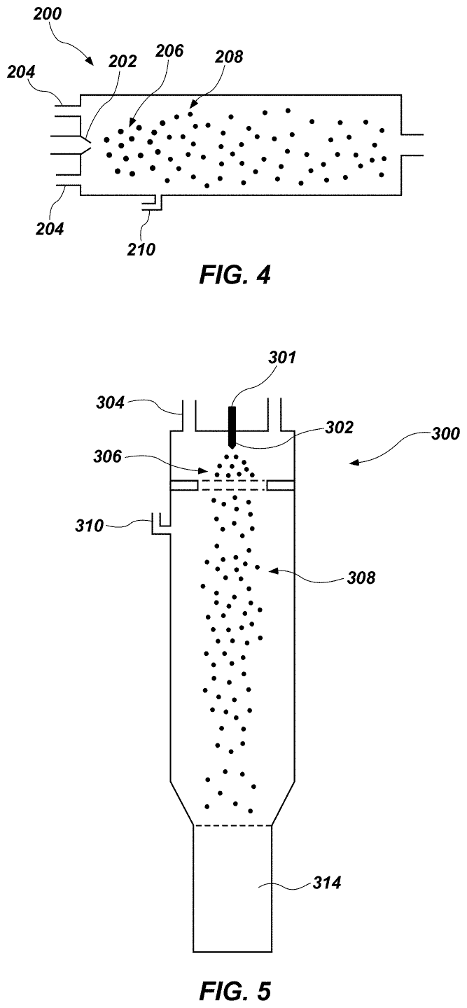

FIG. 4 illustrates a continuous flow reactor 200 in which a carbon oxide may be reduced to form solid carbon. A metal acetate solution may be sprayed into the reactor 200 through one or more nozzles 202. The reactor 200 may contain a gas that enters through one or more gas inlets 204, 210. The nozzles 202 may disperse the solution to form droplets 206. The solvent may evaporate as the droplets 206 travel through the reactor 200, leaving particles 208 of the metal acetate. The particle size of the particles 208 may vary based on the concentration of the metal acetate in the solution, the flow rate and pressure within the reactor 200 as well as within the nozzles 202.

The gas may react in the presence of the particles 208 of the metal acetate, as described above, to form solid carbon on the particles 208. In some embodiments, a portion of the gas may be supplied to the reactor 200 downstream of a point at which the solvent has evaporated, such as through one or more gas inlets 210. For example, the carbon oxide may be supplied to the reactor 200 via the gas inlets 204 at or near the nozzles 202, and the reducing agent may be supplied via the secondary gas inlets 210. Such an arrangement may prevent the carbon oxide from reacting with the reducing agent in the presence of the droplets 206 before the solvent has evaporated. As another example, an inert carrier (e.g., argon, nitrogen, etc.) may be supplied to the reactor 200 via the gas inlets 204 at or near the nozzles 202, and the carbon oxide and reducing agent may be supplied via the secondary gas inlets 210. In some embodiments, additional secondary gas inlets 210 may be provided along the length of the reactor 200 to maintain the gas concentration therein within selected parameters (e.g., as the carbon oxide or reducing agent is consumed, more of either gas may be added downstream). The particle size of the resulting solid carbon may be precisely controlled due to control of the size of the particles 208 of the metal acetate, upon which the carbon is formed.

FIG. 4 depicts spraying the solution horizontally, but the reactor 200 may also be configured to spray the solution vertically downward. In such embodiments, gravity may assist in moving the droplets 206 and the particles 208 through the reactor 200.

FIG. 5 illustrates another continuous flow reactor 300 in which a carbon oxide may be reduced to form solid carbon. The reactor 300 may include a capillary tube 302 through which a metal acetate solution 301 may be provided into the reactor 300. The reactor 300 may contain a gas that enters through one or more gas inlets 304, 310. The capillary tube 302 may disperse the solution 301 in an electrospray process to form droplets 306. The solvent may evaporate as the droplets 306 travel through the reactor 300, leaving particles 308 of the metal acetate. Though only one capillary tube 302 is shown in FIG. 5 for simplicity and clarity, the reactor 300 may include an array of capillary tubes 302.

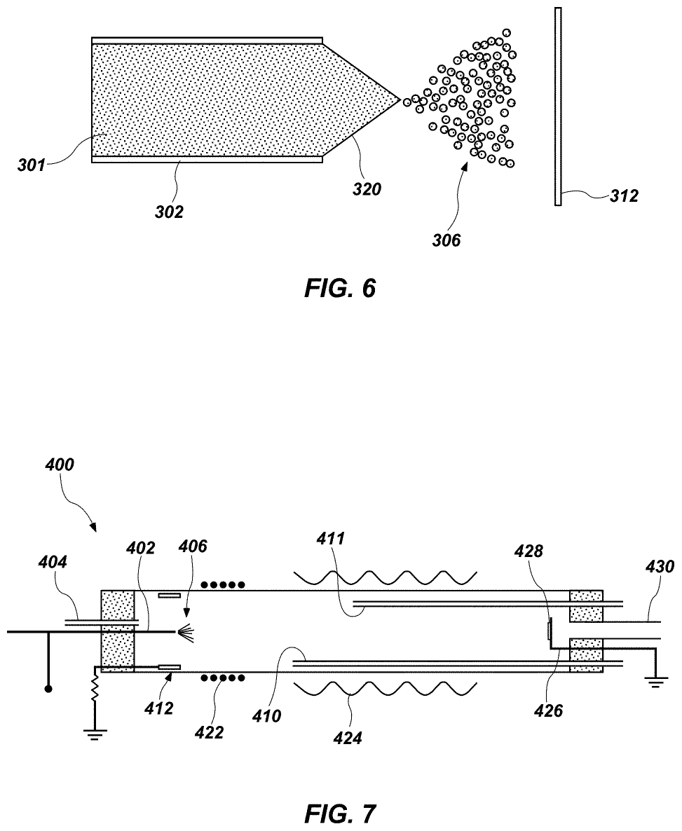

FIG. 6 shows a capillary tube 302 in more detail. The capillary tube 302 may be held at a high voltage (i.e., potential) and placed near a counter electrode 312. The voltage may be, for example, from about 1,000 volts DC to about 200,000 volts DC, such as from about 5,000 volts DC to about 50,000 volts DC. As the solution 301 flows through the capillary tube 302, the solution 301 is introduced to the electric field formed from the voltage differential between the capillary tube 302 and the electrode 312. The electric field may cause opposite charges to form on the solution 301 and the electrode 312, which may result in a Coulomb force pulling the solution 301 toward the electrode 312. If the force is sufficiently large, the solution 301 may form a Taylor cone 320, in which the highest charge density is at the tip. When this charge concentration is high enough, the Coulomb force may overcome the intermolecular forces that hold the solution 301 together, causing the solution 301 to break apart into droplets 306. Prior to formation of the droplets 306, the charges may be spaced uniformly within the region around the tip of the Taylor cone 320. As a result, the solution 301 may break apart at the tip consistently and uniformly, forming droplets 306 that are consistent in both size and charge content. The droplets 306 may form a plume or cloud.

If the environment in the reactor is electrically nonconductive (e.g., hydrogen), a single Taylor cone 320 may be formed. A more conductive environment (e.g., carbon monoxide) may cause a multi-jet effect, which may in turn cause the formation of multiple Taylor cones 320. Multiple Taylor cones 320 may also be formed by providing the solution 301 through multiple capillary tubes 302. The number of Taylor cones 320 may be used to control the size of droplets 306 by changing the volume over which the solution is spread.

The particle size of the droplets 306, and thus of the particles 308, may vary based on the concentration of the metal acetate in the solution 301; the chemical composition of other components of the solution 301; the flow rate, pressure, and gas composition within the reactor 300; the flow rate of the solution 301; the voltage applied to the capillary tube 302; and the temperature of the reactor 300. In some embodiments, the solution 301 may include an additive to change the conductivity of the solution 301 and the particle size distribution of the droplets 306 formed. For example, acetic acid may be added to a solution of ethanol and iron acetate to change the conductivity without changing the concentration of iron.

The droplets 306 and particles 308 may travel along the length of the reactor 300 toward and/or past the electrode 312. The electrode 312 may be a ground, and may be shaped such that a plane defined by the electrode 312 intersects the travel path of the droplets 306 and/or the particles 308. Thus, the electrode 312 may form an effective ground plane intersecting the travel path of the droplets 306 and/or the particles 308. For example, the electrode 312 may be a circular ring electrode encircling the path of travel of the droplets 306 and/or the particles 308, such that the droplets 306 and/or the particles 308 do not impinge on the electrode 312. In other embodiments, the electrode 312 may be a wire grid. The droplets 306 and/or the particles 308 may travel generally along lines parallel to a longitudinal axis of the reactor 300, particularly after passing the electrode 312.

An electrospray process can be used to form particles 308 of catalyst material having a tightly controlled diameter. For example, electrospray processes as described may be used to control the diameter of the particles 308 within about +/−5 nm (nanometers) by controlling the conditions at which the droplets 306 are formed, particularly the concentration of the metal acetate in the solution 301, the voltage applied, the diameter of the capillary tube 302, and the flow rate of the solution 301. As a result, these factors may all be varied, resulting in considerable control over the size of the particles 308 in the reactor 300.

The particles 308 may be used to catalyze growth of nanostructured carbon. In some embodiments, the particles 308 may react, such as with a gaseous reducing agent, to form elemental metal nanoparticles. For example, if the solution 301 contains iron acetate in a solvent, the droplets 306 may also include iron acetate in the solvent. The solvent may evaporate, leaving iron acetate particles. In the presence of heat and a reducing agent (e.g., hydrogen), the iron acetate may form iron nanoparticles. Hydrogen and carbon monoxide, for example, may react to form solid carbon on the iron nanoparticles. In some embodiments, the particles 308 having solid carbon thereon may enter a collection vessel 314, such as a drum or hopper. The collection vessel 314 may be separated from the reactor 300 after a period of time to remove the particles 308 having solid carbon thereon.

### EXAMPLES

### Example 1: Batch Mode Carbon Formation on Iron (II) Acetate

A 0.5% mixture by weight of iron (II) acetate in ethanol was prepared by mixing 14.98 g of iron (II) acetate with 2,998 g of 200 proof ethanol, each available from Sigma-Aldrich, of St. Louis, Mo. A quartz cup was filled with the mixture, then placed into an oven heated to 75° C. After the ethanol evaporated, the quartz cup was placed in a reaction chamber. The reaction chamber was sealed, then a vacuum was drawn within the reaction chamber until the pressure was below 20 mmHg. Nitrogen was added to the reaction chamber to bring the reaction chamber up to atmospheric pressure. This purge-and-refill process was repeated to remove oxygen from the reaction chamber.

Hydrogen and carbon monoxide were both provided to the reaction chamber at flow rates of 2,000 sccm (standard cubic centimeters per minute) each, with a purge valve open. These reaction gases flowed out through the purge valve for 5 minutes, after which the purge vale was closed. After the pressure in the reaction chamber reached 10 psig (69 kPa), a heater was switched on to heat the reaction chamber to a set point of 625° C. Gases leaving the reaction chamber were cooled using a glycol circulation system to condense and remove water. Once the temperature in the reaction chamber reached 625° C., the hydrogen and carbon monoxide gases continued flowing through the reaction chamber for 3 hours.

The heater was switched off, and the hydrogen and carbon monoxide flows were terminated. Argon was provided through the reaction chamber at a flow rate of 2,000 sccm. The purge valve was opened to allow the pressure to drop to 0 psig. Once the temperature dropped below 350° C., the flow of argon was terminated. Once the temperature dropped to ambient, the reaction chamber was opened, and the quartz cup was removed. It was observed that the carbon nanofibers had formed in the quartz cup.

### Prophetic Example 2: Continuous Formation of Carbon on Iron (II) Acetate

A mathematical model was performed to model the growth rate of CNTs for an electrospray reactor (e.g., reactor 300, shown in FIG. 5) having 100 capillary tubes. The calculations assumed the reactor would operate 24 hours a day and 7 days per week while producing mostly single wall CNTs. The CNTs were estimated to be about 2 microns in length. It was also assumed that a solution of 0.5% iron (II) acetate in ethanol would flow from each capillary tube at a rate of 4 μL/min. At 100% efficiency (i.e., all particles catalyze the formation of CNTs thereon), this reactor would form 180 g of CNTs per week, and would consume about 4 L of ethanol and 16 g of iron (II) acetate per week. If hydrogen and carbon monoxide are used as the reaction gases and are used in equal measures (using a flow rate of 600 sccm), the reactor would consume about 6,000 L of each gas per week (measured at standard temperature and pressure conditions).

The calculated growth rate was strongly dependent on the size of iron particles produced from the electrospray: a decrease in the particle radius changes the mass of iron in the particle by a factor of 1/r³, while it only changes the mass of the grown CNT by a factor of 1/r. For a fixed mass flow rate of iron, smaller particles correspond to a greater number of particles and a greater number of CNTs formed. This may cause an increase in growth rate and a decrease in CNT diameter as particle size is scaled down.

### Example 3: Continuous Formation of Carbon on Iron (II) Acetate

CNTs were formed in a reactor 400 comprising a quartz tube, shown in FIG. 7. A solution of 1% iron (II) acetate in ethanol was prepared. The solution was provided to a capillary tube 402, which was a stainless steel tube having a nominal outside diameter of 1/16″ (1.59 mm) and an inside diameter of 0.005″ (0.127 mm). A voltage of −25,000 V DC was applied to the capillary tube 402 and a voltage of −12,800 V DC was measured at a circular counter electrode 412 mounted adjacent a wall of the reactor 400. The counter electrode 412 was a metal screen. A plume of droplets 406 was formed from the solution leaving the capillary tube 402.

A nitrogen environment was provided in the region of the reactor 400 near the capillary tube 402 by adding nitrogen through a gas inlet 404 at a flow rate of 200 sccm. The nitrogen helped to carry droplets 406 along the length of the reactor 400 while the ethanol evaporated from the droplets 406. The ethanol appeared to also reduce the iron (II) acetate, leaving nanoscale iron particles. A cooling coil 422 was wrapped around the reactor 400 near the capillary tube 402 to keep that section of the reactor 400 at a temperature of about 100° C. and keep the ethanol from evaporating too quickly (which quick evaporation was observed to clog the capillary tube 402).

The droplets 406 then entered a section of the reactor 400 having a heating element 424. The heating element heated the gases and particles in that section of the reactor 400 to a temperature of about 600° C. Hydrogen was added to the reactor 400 through a gas inlet 410 at a flow rate of 600 sccm. The hydrogen passed through the heated section of the reactor 400 to preheat the hydrogen before the hydrogen was mixed with the nitrogen, ethanol, and iron particles. The hydrogen may have also helped to reduce any remaining iron (II) acetate.

Carbon monoxide was added to the reactor 400 through a gas inlet 411 downstream of the gas inlet 410 at a flow rate of 600 sccm. The carbon monoxide also passed through the heated section of the reactor 400 to preheat the carbon monoxide before the carbon monoxide was mixed with the nitrogen, ethanol, and iron particles.

A mount 426 was provided near the end of the reactor 400 to hold a target 428 (e.g., a square piece of silicon or a TEM grid) to capture solid carbon formed in the reactor 400 as the gases flowed out of the reactor 400 through an exhaust port 430.

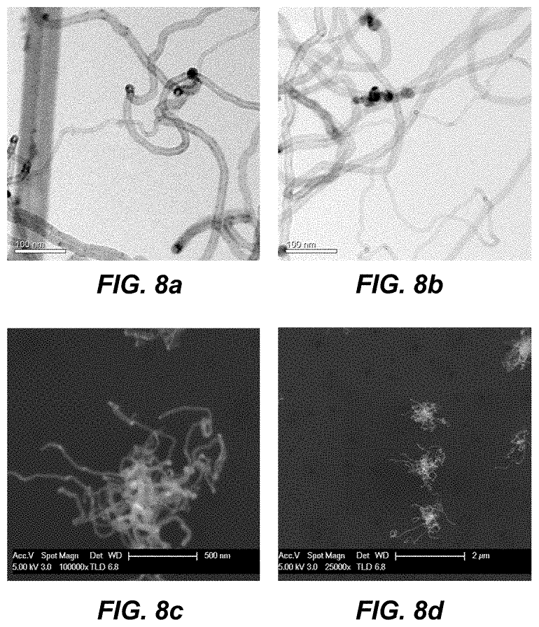

FIG. 8 shows images of the material collected on the targets 428. Images (a) and (b) show TEM images of material collected on TEM grids. The TEM images show that CNTs were formed, although the resolution was not high enough to verify the number of walls. The diameter distribution observed indicates that CNTs were formed ranging from a few walls to many walls. Images (c) and (d) show SEM images of the CNTS collected on silicon.

1. A method of reducing a carbon oxide to a lower oxidation state, the method comprising:
providing a solution of a metal acetate in a solvent in a reaction vessel;
evaporating the solvent to leave a film of the metal acetate on an interior surface of the reaction vessel; and
reacting a carbon oxide with a gaseous reducing agent in the reaction vessel to produce a solid carbon product on the metal acetate.

2. The method of claim 1, further comprising oxidizing at least a portion of the metal acetate.

3. The method of claim 1, wherein the solvent comprises at least one solvent selected from the group consisting of methanol, ethanol, isopropanol, and specially denatured alcohol.

4. The method of claim 1, wherein reacting a carbon oxide with a gaseous reducing agent comprises forming solid carbon and water.

5. The method of claim 4, further comprising removing the water from the reaction vessel while reacting the carbon oxide with the gaseous reducing agent.

6. The method of claim 1, wherein providing a solution of a metal acetate comprises providing a solution of a metal acetate comprising iron (II) acetate.

7. The method of claim 1, further comprising forming an elemental metal from the metal acetate.

8. The method of claim 1, wherein providing a solution of a metal acetate in a solvent comprises providing a solution comprising acetic acid.

9. The method of claim 1, wherein reacting a carbon oxide with a gaseous reducing agent in the reaction vessel comprises reacting carbon dioxide with a gaseous reducing agent at a temperature of about 500° C. or higher.

10. A method of reducing a carbon oxide to a lower oxidation state, the method comprising:
dispersing droplets in a gas, the droplets comprising a solution of a metal acetate in a solvent;
evaporating the solvent to form particles comprising the metal acetate;
reacting a carbon oxide with a gaseous reducing agent in the presence of the particles to produce a solid carbon product thereon.

11. The method of claim 10, wherein dispersing droplets comprising a solution of a metal acetate in a solvent comprises spraying the solution through a nozzle.

12. The method of claim 11, wherein spraying the solution through a nozzle comprises spraying the solution downward.

13. The method of claim 10, wherein dispersing droplets comprising a solution of a metal acetate in a solvent comprises applying a voltage to a capillary tube containing the solution.

14. The method of claim 10, wherein dispersing droplets in a gas comprises dispersing droplets comprising a solution comprising acetic acid in the gas.

15. The method of claim 10, wherein reacting a carbon oxide with a gaseous reducing agent in the presence of the particles comprises reacting carbon dioxide with a gaseous reducing agent at a temperature of about 500° C. or higher.

16. An apparatus for forming solid carbon, the apparatus comprising:
a capillary tube configured to receive a solution and emit the solution generally along a line perpendicular to an opening of the capillary tube;
an electrode surrounding the line without intersecting the line; and
a voltage source connected to the capillary tube, the voltage source having a higher potential than the electrode.

17. The apparatus of claim 16, further comprising an array of capillary tubes.

18. The apparatus of claim 16, wherein the electrode forms an effective ground plane intersecting the line.

19. The apparatus of claim 16, wherein the electrode comprises a ring encircling the line.
